(19) United States
(12) Patent Application Publication
(10) Pub. No.: US 2005/0040271 A1
(43) Pub. Date: Feb. 24, 2005

(54) Method and apparatus to provide radial and axial registration of a tape cartridge supply hub

(76) Inventors: Ken Netzel, Loveland, CO (US); Christopher Rathweg, Louisville, CO (US)

Correspondence Address: MORRISON & FOERSTER LLP, 755 PAGE MILL RD, PALO ALTO, CA, 94304-1018, US

(21) Appl. No.: 10/645,728

(22) Filed: Aug. 20, 2003

(51) Int. Cl. G11B 15/32

(52) U.S. Cl. 242/340; 242/348

(57) ABSTRACT

A reel driver device for driving a magnetic tape cartridge supply hub is provided. The reel driver includes a cylindrical reel driver having a toothed upper surface configured to engage a supply reel hub, spline elements disposed along an axial direction of the reel driver, and a stop element. At least one of the spline elements is disposed a first distance from the teeth, and the stop element is disposed a second distance from the teeth, the second distance being greater than the first distance. The spline elements are disposed circumferentially around the hub of the spindle motor allowing for reduced radial runout, and the stop element disposed the second distance from the teeth may abut a reel plate registered to a portion of the motor for reduced axial runout.

### BACKGROUND OF THE INVENTION

1. Field of the Invention

The present invention relates generally to magnetic tape read/write drives, and more particularly to magnetic tape read/write drives including a reel driver with improved radial and axial runout control with a tape cartridge or cassette supply hub.

2. Description of the Related Art

Increased data storage capacity and retrieval performance is desired of all commercially viable mass storage devices. Magnetic tape devices, such as cartridges and cassettes, continue to be an efficient and effective manner for data storage in computer systems and are widely used for storing information in digital form. In the case of linear tape recording, e.g., streaming a magnetic tape past a read/write head, a popular trend is towards multi head, multi-channel fixed head structures with narrowed recording gaps and data track widths so that many linear data tracks may be achieved on a tape medium of a predetermined width, such as one-half inch width tape. To increase the storage density and reduce access time of magnetic tapes, data tracks on the tape are arranged with greater density and the tape is streamed by a tape head at increasingly faster rates.

Increased storage density and linear speed may lead to higher error rates when reading and/or writing on the tape due to lateral tape motion. Lateral tape motion generally refers to transverse motion relative to a read/write head in a tape drive as the tape streams by the head, and is generally defined as the peak-to-peak distance of the undesirable movement (in-plane) of the tape perpendicular to its prescribed longitudinal direction of motion past a read/write head. Lateral tape motion may cause errors in a read or write process because the head is unable track a particular data track. Lateral tape motion and the ability to compensate for lateral tape motion is a major limiting factor in determining the minimum width of a track and the minimum spacing between tracks on the tape. Thus, as lateral tape motion is reduced, tracks may be stored more densely on the storage tape and may increase the storage tape capacity.

Magnetic tape is generally housed in a cartridge or cassette on one or more reels. The supply hub within the cartridge housing magnetic tape is coupled to a reel driver of the tape drive to drive or stream the tape by the read/write head. One type of tape drive, often referred to as a “soft load” tape drive system, includes a mechanism that aligns and engages the supply hub of a cartridge with the reel driver of the tape drive by lowering the cartridge onto the reel driver. Such a system, however, includes complicated and expensive mechanisms for receiving and lowering the cartridge onto the reel driver.

Alternatively, the cartridge and supply hub may be disposed above the reel driver and the reel driver may translate up and engage the supply hub. If the engagement is not precise because of an offset, e.g., radial or axial offset, the tape path may vary and excess lateral tape motion may result from radial or axial runout. Thus, reliable and secure coupling of the reel driver and tape reel may reduce lateral tape motion and create a more repeatable tape path in the drive. The coupling is generally achieved by engaging tightly matched features formed on opposing surfaces of the reel driver and supply reel. The tightly matched features allow the reel driver to rotate the supply reel to supply tape to a take-up reel in a drive or within a cassette with little radial or axial runout. Relatively small mismatches in the matched features or teeth, however, may cause runout control and axial location difficulties. Additionally, if the reel driver fails to fully engage the supply hub spurious tape loading or tape tension errors may result in increased lateral tape motion and errors in reading and/or writing processes. Further, the precisely matching features increase the cost of the drives and cartridges.

A need exists therefore for a tape reel driver and tape drive system with increased radial and axial control during operation. Increased radial and axial control during operation may reduce lateral tape motion and improve the performance of tape drives. Further, a tape reel driver and tape drive system with reduced tolerances, manufacturing complexity, and cost is desired.

### BRIEF SUMMARY OF THE INVENTION

In one exemplary embodiment an assembly for driving a magnetic tape storage device is provided. The exemplary assembly includes a cylindrical reel driver having a toothed upper surface configured to engage a supply reel hub of a magnetic tape storage device (e.g., a cartridge), spline elements disposed along an axial direction of the reel driver, and a stop element. The assembly further includes a motor to rotate the reel driver, wherein the spline elements are disposed circumferentially around and adjacent a portion of the motor allowing for reduced radial runout. For example, an inner diameter associated with the circumferentially disposed spline elements or ribs may be registered directly to an outer diameter of a motor hub to locate the reel driver and reduce radial runout. The stop element is adapted to abut a portion of the motor or a reel plate associated with the motor after a predetermined axial translation of the reel driver for reduced axial runout. For example, a reel plate or the like may include a planar surface that is coplanar or registered with a planar surface of the motor.

In another exemplary embodiment a method for driving a magnetic tape cartridge supply hub with a reel driver assembly is provided. The method includes translating a reel driver in an axial direction to engage a supply hub of a magnetic tape storage device and rotating the reel driver with a spindle motor, where the reel driver is coupled to the spindle motor through a spline joint. Further, the reel driver includes spline elements that are disposed circumferentially around a portion of the motor and may interact with a splined reel plate allowing the reel driver to move in an axial direction with reduced radial runout.

The present invention and its various embodiments are better understood upon consideration of the detailed description below in conjunction with the accompanying drawings and claims.

### BRIEF DESCRIPTION OF THE DRAWINGS

FIG. 1 illustrates a top plan view of a portion of a tape drive having an exemplary reel driver and a cartridge in partial cut-away adjacent to the tape drive;

FIG. 2 illustrates an exploded view of an exemplary tape drive including a splined reel driver and reel plate;

FIG. 3A illustrates a perspective view of an exemplary reel driver within a tape drive adjacent a supply hub of a tape cartridge;

FIG. 3B illustrates a perspective cross-sectional view of an exemplary reel driver assembly;

FIG. 4 illustrates a perspective view of an exemplary reel driver having spline elements located on the inner surface of the reel driver;

FIG. 5 illustrates an exemplary reel plate having spline elements; and

FIG. 6 illustrates an exemplary system for translating the reel driver in an axial direction.

### DETAILED DESCRIPTION OF THE INVENTION

The following description is presented to enable any person skilled in the art to make and use the invention. Descriptions of specific materials, techniques, and applications are provided only as examples. Various modifications to the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the scope consistent with the appended claims.

One exemplary reel driver includes a plurality of ribs, e.g., 6 ribs, extending axially along the inner diameter of the reel driver to provide radial and axial registration of the reel driver with the supply hub during a cartridge loading operation and during tape motion. A portion of the ribs, e.g., 3 ribs, may be circumferentially disposed around and register directly with a portion of a motor, e.g., a spindle motor, to locate the reel driver and provide increased control of radial runout. For instance, the ribs may be disposed with an inner diameter adjacent an outer diameter of a portion of the spindle motor, e.g., the hub. The ribs may also interact with a splined member, e.g., a reel plate, associated with the motor to allow for rotational control of the reel driver.

A second portion of the ribs, e.g., 3 ribs, may include shortened pads with planar upper surfaces adapted to engage and provide a stop element with a splined member, reel plate, or portion of the motor thereby providing axial registration of the reel driver with respect to the splined member and motor. In one example, a reel plate, that may be splined, includes a planar surface coplanar or registered directly to a planar surface of the motor, e.g., the motor hub, to provide a planar stop with the shorter ribs. Therefore, a splined member, e.g., a reel plate fitting within the reel driver, may include slots corresponding to the longer ribs or spline elements of the reel driver for radial control of the reel driver and serve as a planar stop to the shorter ribs when the reel driver extends to a distance where the shorter ribs abut the reel plate.

The improved drive assembly may provide improved radial and axial control throughout the radial and axial motion of the reel driver. For example, by reducing the number of interacting components, i.e., tolerance dimensions of the stack forming the reel driver, the radial and axial runout may be reduced as described in greater detail below. Further, the reel driver manufacturing, testing, and inspection may be simplified over conventional reel driver assemblies.

Mating portions of an exemplary reel driver and supply hub of a tape cartridge provide a positive engagement between an inline axis spindle motor and the tape cartridge supply hub. Spline connections or joints may be used for transmitting torque between two parts such as a shaft and a hub or two shafts. Generally, a spline connection includes a series of internal spline elements, e.g., slots or grooves, formed on one of the parts that engage a corresponding series of external spline elements, e.g., elongated projections or ribs, formed on the other of the two parts. A spline joint may allow the two parts to slide axially with respect to each other and rotate together.

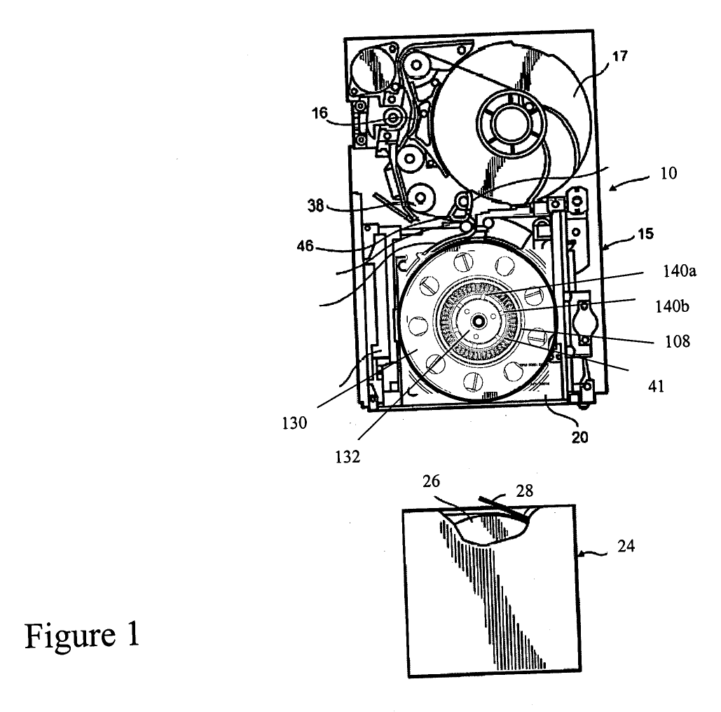

Referring initially to FIG. 1, an exemplary tape drive 10 having a reel driver 108 according to one example is illustrated. Tape drive 10 includes a tape drive housing 15, a read/write head 16, a take-up reel 17, and a receiver 20. Tape drive 10 is used in conjunction with a cartridge reel 24 which houses a storage tape 28 on supply reel 26. Receiver slot 20 is configured to receive a suitable cartridge 24 therein such that supply reel 26 opposes reel driver 108. Tape drive 10 may also include a door and various mechanisms for receiving and ejecting cartridge 24. Reel driver 108 may translate along its axis to the hub of cartridge reel 26 when cartridge 24 is loaded properly in receiver slot 20. A buckler motor 46 or the like may engage the cartridge leader and stream storage tape 28 along a tape path within tape drive 10 passing read/write head 16. The tape path may include various tape guides, rollers 38, one or more read/write heads 16, and the like before being wound upon take-up reel 17.

Tape drive 10 is typically installed within or associated with a computer (not shown) or computer network. Additionally, tape drive 10 may be used as part of an automated tape library having a plurality of tape cartridges and a robotic transfer mechanism to transport cartridges to one or more tape drives. An exemplary storage library is described in U.S. Pat. No. 5,760,995, entitled “MULTI-DRIVE, MULTI-MAGAZINE MASS STORAGE AND RETRIEVAL UNIT FOR TAPE CARTRIDGES,” which is hereby incorporated by reference in its entirety.

It should be understood that the exemplary reel drive assemblies described herein may be used with various tape drives not explicitly discussed. For example, a cassette tape drive, i.e., where a cassette housing includes both the supply and take-up reel, may be used. Additionally, various other features of a tape drive may be included, for example, various buckler systems, rollers, tape guides, receiving mechanisms, dampers, and the like may be used. A detailed description of various components of a tape drive system that may be used is provided in U.S. Pat. No. 6,095,445, entitled “CARTRIDGE BUCKLER FOR A TAPE DRIVE,” which is incorporated herein by reference in its entirety. Accordingly, only the structural aspects of a tape drive 10 which are particularly significant to the present invention are provided herein. A representative tape drive for which an exemplary reel driver may be used is sold by Quantum Corporation under the trademark SDLT™ 320.

Cartridge 24 generally includes a substantially rectangular cartridge housing that encloses cartridge reel 26 and storage tape 28. Cartridge 14 may further include a cartridge door to protect storage tape 28 therein and a cartridge leader (not shown), which is exposed when the door is open. An exemplary storage cartridge that may be used with tape drive 10 and reel driver 108 includes the Super DLTape™ Type I cartridge sold by Quantum Corporation. It should be understood, however, that other magnetic storage devices and drives may be used.

Storage tape 28 stores information in a form, e.g., digital, that may be subsequently retrieved if desired. Storage tape 28 may be approximately one-half inch in width, but larger and smaller widths are contemplated, e.g., 4-8 mm. Typically, storage tape 28 includes a storage surface on one side of storage tape 28 that may be divided into a plurality of tracks along the length of storage tape 28. Alternatively, the data may be recorded in diagonal strips across storage tape 28.

As provided in greater detail below, the reel driver 108 moves in an axial direction to positively engage and drive a mating portion of supply reel 26. Reel driver 108 includes various ribs 140a, 140b disposed circumferentially around and registered to hub 132 of motor 130. Reel driver 108 may also include a reel plate (not shown) in a spline joint with ribs 140a that may control both radial and axial runout and provide reliable axial height of reel driver 108 during operation.

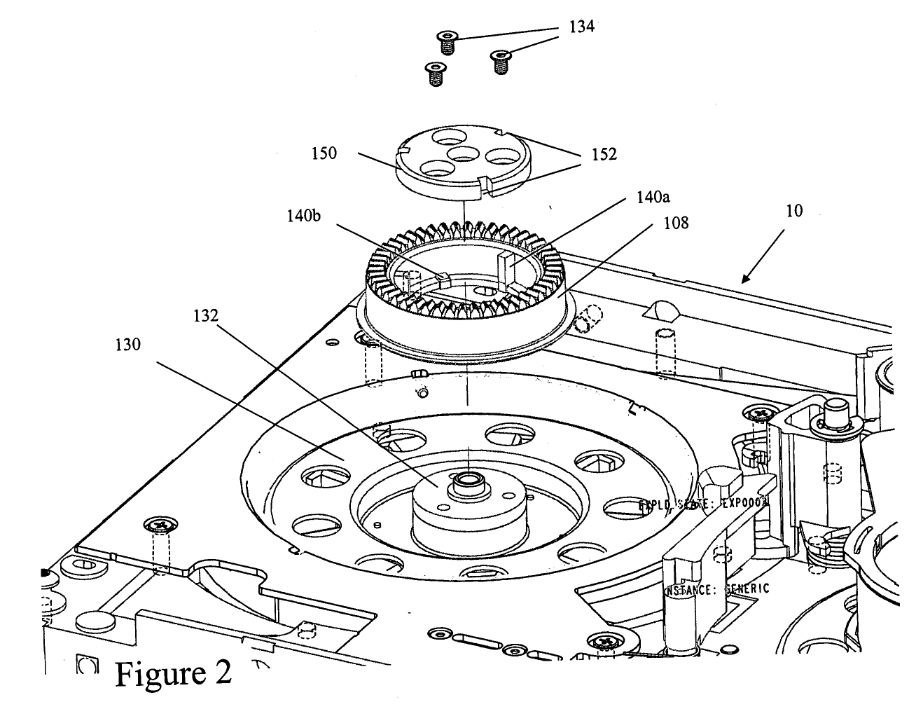

With continued reference to FIG. 1, FIG. 2 illustrates an exploded view of exemplary tape drive 10 illustrating the reel driver assembly in more detail. The tape reel driver assembly includes a reel driver 108, reel plate 150, and motor 130. Reel plate 150 fits within reel driver 108 with spline elements or slots 152 aligned with spline elements or ribs 140a to form a spline joint wherein reel driver 108 and reel plate 150 transfer rotational motion and allow for relative axial translation. Reel plate 150 is fixed to hub 132 by screws 134 allowing reel driver 108 to translate, e.g., float or slide, a certain distance along the axis before abutting reel plate 150. For example, with reel plate 150 fixed to hub 132 of spindle motor 130, the spline joint created with reel driver 108 allows reel driver 108 to move in an axial direction until an upper planar surface of the short ribs 140b contact an opposing planar surface of reel plate 150. Slots 152 only correspond to spline elements or ribs 140a such that short ribs 140b serve as stop elements to prevent further axial motion. Further, as motor 130 rotates reel plate 150, reel driver 108 is rotated by the interaction of spline elements, i.e., slots 152 of reel plate 150 and ribs 140a of reel driver 108. Additionally, ribs 140a are disposed around motor hub 132 to locate or register reel driver 108 to motor hub 132, thereby reducing radial runout during operation.

The assembly of reel driver 108, reel plate 150, and motor 130 form a tolerance stack (or tolerance accumulation) that influences the final radial and axial runout of reel driver 108. Conventional assemblies generally have a tolerance stack in three dimensions, e.g., accumulating the tolerances between a motor and a reel plate, between the reel plate and a reel driver, and between the reel driver and a supply hub. In one example, the present assembly reduces the tolerance stack to two dimensions. Radial runout may be reduced because reel driver 108 interacts and is registered directly with the hub 132 of motor 130 through the long spline elements or ribs 140a being disposed with an inner surface adjacent and fitting tightly around the hub of motor 130. For example, the difference between the inner diameter of spline elements 140a and the outer diameter of the portion of motor 130 may be in the range of 0.001 and 0.003 inches depending on the desired tolerances and application; larger or smaller differences are contemplated. Thus, long ribs 140a are registered to the motor 130 such that there are only two dimensions in the tolerance stack relating to radial runout. Further, having a relatively small number of spline elements or long ribs 140a, e.g., three elements, allows for a reduced number of interacting elements with motor 130 that need to be precisely manufactured and inspected. For instance, it is generally simpler to manufacture, inspect, and correct a reel driver with only three interacting elements as opposed to a continuous circular interior surface coupled with motor 130.

Reducing the dimensions of the tolerance stack may also reduce axial runout. The top surface of the hub of motor 130 is generally a highly planar surface, e.g., because of planar machining and the like. Reel plate 150 may also be made to have a highly planar corresponding bottom surface to engage motor 130. The highly planar surface of the reel plate 150 is mounted or registered directly to the highly planar surface of motor 130. This interaction, including the stop surface of the reel plate 150 coplanar with the mounting surface of motor 130 effectively removes reel plate 150 from the tolerance stack, and reel driver 108 is essentially registered to the highly planar surface of motor hub 132. Again, reducing or simplifying the interactions with a small number of interacting surfaces, in this instance three short ribs 140b, the axial runout may be controlled more precisely.

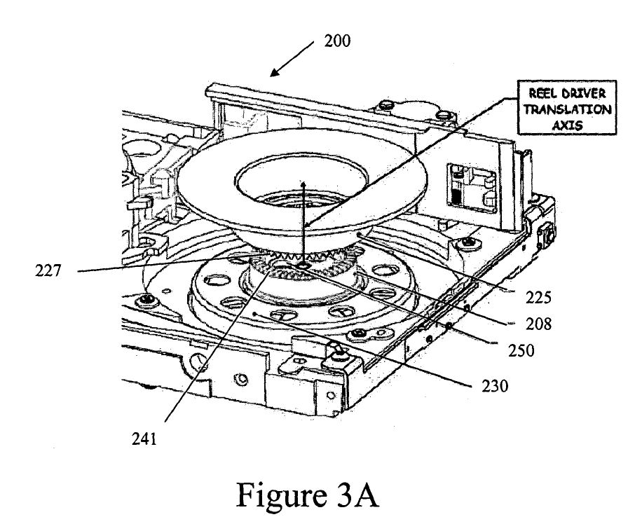

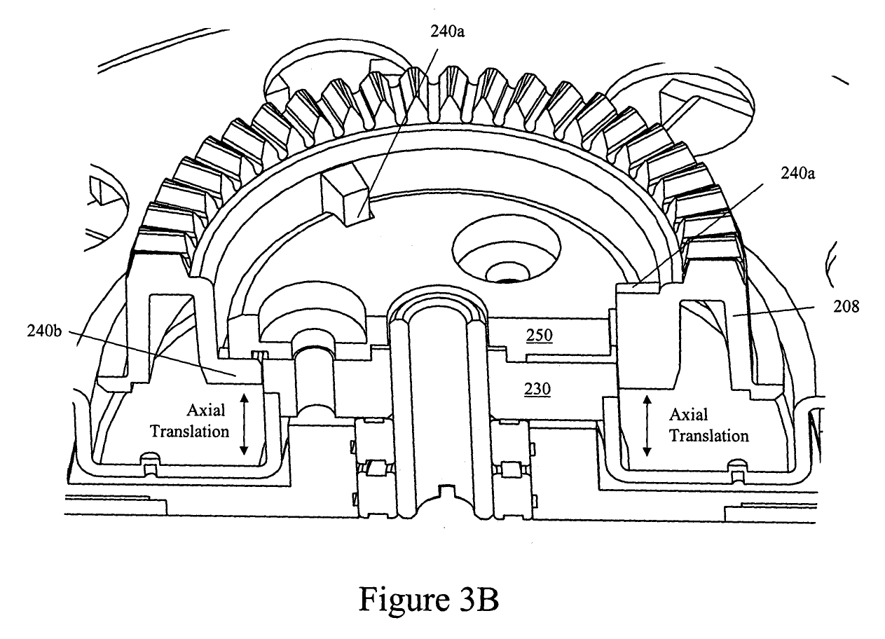

FIG. 3A illustrates a perspective view of an exemplary reel driver 208 disposed within tape drive 200 adjacent supply hub 226 of a tape cartridge (only supply hub 226 of the cartridge is shown for clarity), and FIG. 3B illustrates a perspective cross-sectional view of reel driver 208. Reel driver 208 is mechanically coupled to spindle motor 230 through a spline joint with reel plate 250 and may rotate and translate along the axis of reel driver 208. The axial motion allows reel driver 208 to extend away from the base of drive 200 and engage supply hub 226 without moving spindle motor 230 along the axis of reel driver 208. Reel plate 250 is disposed within reel driver 208 and provides a planar stop with ribs or spline elements that do not match splined reel plate 250. Reel driver 208 may extend long its axis to a repeatable height and engage supply hub 226 with a reduced potential for radial or axial runout.

In operation, a tape cartridge may be inserted into tape drive 200 such that supply hub 226 is positioned approximately axially inline and above reel driver 208. Reel driver 208 translates in the axial direction towards the cartridge and supply hub 226 to engage the teeth 227 of supply hub 226. As reel driver 208 moves in the axial direction one or more stop elements of reel driver 208 are used to provide precise height control with reel plate 250 as shown more clearly in FIG. 3B. In particular, one or more short ribs 240b located on reel driver 208 and below reel plate 250 contact reel plate 250 and provide a stop for reel driver 208 as reel driver 208 translates in the axial direction. Further, reel plate 250 includes a lower planar surface registered or coplanar with an upper planar surface of the hub of motor 230. This interaction provides increased control and repeatability of the height of reel driver 208 to engage supply hub 226.

Additionally, ribs 240a, which extend a greater distance in the axial direction towards teeth 241, are circumferentially disposed around hub 230 to improve radial runout during operation. Further ribs 240a are aligned with spline elements, e.g., slots, in reel plate 250 to create a spline joint with reel driver 208. Reel plate 250 is coupled to and rotated by the spindle motor 230 to rotate reel driver 208 through the spline joint. Spindle motor 230 may rotate reel driver 208 when teeth 241 of reel driver 208 engage teeth 227 of supply hub 226 thereby rotating supply hub 226. It should be understood that the spline joint could also be made by slots in reel driver 208 and ribs or protrusion in reel plate 250, or any combination of internal and external spline elements on reel driver 208 and reel plate 250.

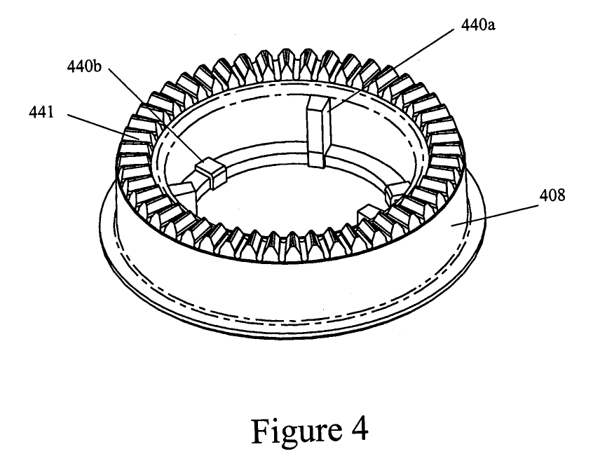

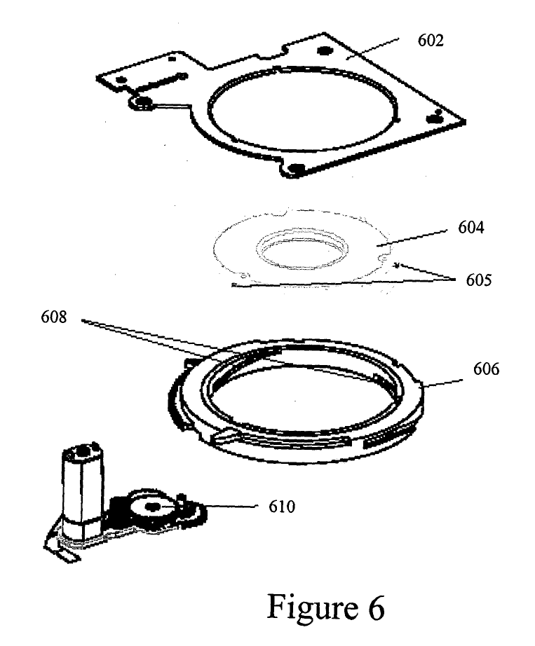

The different height ribs forming spline elements and stop elements are illustrated more clearly in FIG. 4, and may be referenced in conjunction with FIGS. 1-3B. Specifically, FIG. 4 illustrates a perspective view of an exemplary reel driver 408 with ribs 440a and 440b. In this example, ribs 440a and 440b extend along the axial direction and are spaced evenly around the inside of reel driver 408. Ribs 440a extend axially up towards the supply hub to a height greater than ribs 440b. Ribs 440a are adapted to be disposed circumferentially around and adjacent a motor hub to reduce radial runout. Ribs 440a are also adapted to be aligned with slots in the reel plate (shown in detail in FIG. 6) to provide a spline joint for radial and axial control as reel driver 408 moves axially to engage the supply hub and rotates to rotate the supply hub. Ribs 440b, which are not aligned with a slot in the reel plate, stop against the reel plate as reel driver 408 extends a predetermined distance axially to provide increased axial control of reel driver 408. In this example, ribs 440b are also adapted to be disposed circumferentially around and adjacent a motor hub to reduce radial runout.

Ribs 440a and 440b may be integral, e.g., co-molded, with reel driver 408. Alternatively, ribs 440a and 440b may be attached in any suitable manner to the inner surface of reel driver 408. Reel driver 408 further includes a plurality of teeth 441 formed on the upper surface of reel driver 408 and are, for example, integral with reel driver 408. Teeth 441 may take any suitable form or shape capable of driving a supply reel such as triangles, trapezoids, castellations, and the like. Reel driver 408 may be made by any suitable manufacturing method and include plastics, metals, or the like. In one example, reel driver 408 is injection molded to desired dimensions.

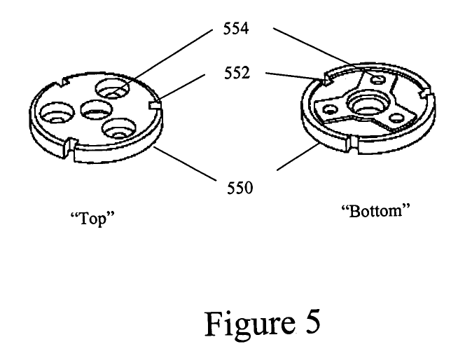

FIG. 5 illustrates a top and bottom perspective view of an exemplary reel plate 550. In this example, reel plate 550 includes three slots 552 corresponding to the position and number of long ribs or spline elements in the reel driver (not shown). Reel plate 550 further includes three holes 554 allowing screws to secure reel plate 550 to the hub of the drive motor (see FIG. 4). Reel plate 550 may be secured or coupled to a drive motor by any suitable method. Generally, reel plate 550 is configured to create a spline joint with the spline elements, e.g., the long ribs of the reel driver that engage and locate or register with the hub of the spindle motor, and provide a planar surface registered to a planar surface of the motor that may interact with a stop element, e.g., the short ribs, of the reel driver. It should be understood, that various other configurations and numbers of slots and/or holes may be used and are contemplated depending on the particular application.

FIG. 6 illustrates an exemplary system for translating the reel driver in the axial direction. The reel driver (not shown) may be mounted or coupled to a mounting plate 602 that sits above a ring driver 604 and load ring 606. In operation a motor gear set 610 is activated to rotate load ring 606. Load ring 606 includes internal cam slots 608, and hardened pins 605 on the ring driver 604 are disposed with the internal cam slots 608. The ring driver 604 is in a radially fixed position, i.e., it does not rotate. As load ring 606 rotates, pins 605 and ring driver 604 are raised or lowered based on the position of internal cam slots 608. Ring driver 604 in turn raises and lowers mounting plate 602 and the reel driver in an axial direction. It should be recognized that various other systems and methods for translating a reel driver in an axial direction are possible and contemplated.

In another example, a spring or biasing element may be disposed between the reel driver and the spindle motor. The biasing element may bias the. reel driver against the reel plate in an extended position. During insertion or removal of a cartridge the reel driver may be selectively forced down by a suitable mechanism or by the cartridge itself. The biasing element will force the reel driver back into an extended position when the cartridge is in a suitable position or has been removed.

The above detailed description is provided to illustrate exemplary embodiments and is not intended to be limiting. It will be apparent to those skilled in the art that numerous modification and variations within the scope of the present invention are possible. For example, various configurations of spline elements including slots, grooves, protrusions, ribs, and the like within the reel driver and reel plate are possible. Further, numerous other structures and methods not explicitly described herein may be used within the scope of the exemplary methods and structures described as will be recognized by those skilled in the art. Accordingly, the present invention is defined by the appended claims and should not be limited by the description herein.

1. An assembly for driving a magnetic tape storage device, comprising:
a cylindrical reel driver having,
teeth configured to engage a supply reel hub of a magnetic tape storage device,
spline elements extending along an axial direction of the reel driver, and
a stop element, wherein at least one of the spline elements is disposed a first distance from the teeth of the reel driver, and the stop element is disposed a second distance from the teeth of the reel driver, the second distance greater than the first distance; and
a motor configured to rotate the reel driver, wherein the spline elements are disposed circumferentially around and adjacent a portion of the motor.

2. The device of claim 1, further including a reel plate having a planar surface registered to a portion of the motor having a planar surface, the reel plate positioned to abut the stop element.

3. The device of claim 1, wherein the spline elements are located on an interior surface of the reel driver.

4. The device of claim 1, wherein the spline elements include external projections.

5. The device of claim 1, wherein the spline elements are disposed around a hub of the motor.

6. The device of claim 1, wherein a difference between an inner diameter associated with the circumferentially disposed spline elements and an outer diameter of the portion of the motor is between approximately 0.001 and 0.003 inches.

7. The device of claim 1, wherein the stop element is disposed adjacent the portion of the motor.

8. The device of claim 1, wherein the stop element includes a protrusion disposed on an interior surface of the reel driver, the stop element having a planar upper surface.

9. The device of claim 1, further including a splined member coupled to the motor that engages at least a portion of the spline elements of the reel driver.

10. The device of claim 9, wherein the splined member includes a disc with spline elements corresponding to the spline elements of the reel driver.

11. The device of claim 9, wherein the splined member includes a planar surface corresponding to the location of the stop element.

12. The device of claim 1, further including a splined disc having spline elements corresponding to the spline elements of the reel driver, wherein the splined disc contacts the stop element when the reel driver is moved a predetermined distance in the axial direction relative to the splined disc and is registered to a planar surface of the motor.

13. A magnetic tape drive, including
a cylindrical reel driver having,
teeth configured to engage a supply reel hub of a magnetic storage tape device,
spline elements extending along an axial direction of the reel driver, and
a stop element, wherein at least one of the spline elements is disposed a first distance from the teeth of the reel driver, and the stop element is disposed a second distance from the teeth of the reel driver, the second distance greater than the first distance;
a splined member coupled to the spline elements of the reel driver; and
a first motor configured to rotate the splined member, wherein an inner diameter associated with circumferentially disposed spline elements is registered circumferentially around a portion of the first motor.

14. The tape drive of claim 13, wherein the splined member includes a planar surface coplanar with a planar surface of the first motor and disposed to abut the stop element.

15. The tape drive of claim 13, wherein the difference between the inner diameter of the spline elements and an outer diameter of the portion of the first motor is between approximately 0.001 and 0.003 inches.

16. The tape drive of claim 13, wherein the spline elements are disposed circumferentially around a hub of the first motor.

17. The tape drive of claim 13, wherein the stop element is disposed adjacent a portion of the first motor.

18. The tape drive of claim 13, wherein the stop element includes two or more protrusions disposed adjacent a hub of the first motor.

19. The tape drive of claim 13, further including a second motor configured to translate the reel driver in an axial direction.

20. The tape drive of claim 13, wherein the spline elements of the reel driver are located on an interior surface of the reel driver.

21. The tape drive of claim 13, wherein the splined member includes a disc having spline elements corresponding to the spline elements of the reel driver.

22. The tape drive of claim 13, wherein the splined member includes a planar surface corresponding to the stop element of the reel driver.

23. The tape drive of claim 13, wherein the splined member includes a splined disc having spline elements corresponding to the spline elements of the reel driver, and the splined disc contacts the stop element of the reel driver when the reel driver is moved a predetermined distance in the axial direction relative to the splined disc.

24. A reel driver for driving a tape cartridge, comprising:
a cylindrical reel driver having a toothed upper surface configured to engage a supply reel hub of a magnetic tape storage device;
spline elements extending along an axial direction of the reel driver and disposed a first distance from the teeth of the reel driver, wherein the spline elements are adapted to be disposed circumferentially around a portion of a motor; and
a stop element disposed a second distance from the teeth of the reel driver, the second distance greater than the first distance.

25. The device of claim 24, wherein the spline elements are located on an interior surface of the reel driver.

26. The device of claim 24, wherein the spline elements include external projections.

27. The device of claim 24, wherein the stop element is adapted to be disposed circumferentially around a portion of the motor.

28. The device of claim 24, wherein the stop element includes a protrusion disposed on the interior surface of the reel driver having a planar upper surface.

29. A method for driving a magnetic tape storage device with a reel driver assembly, comprising:
translating a reel driver in an axial direction to engage a supply hub of a magnetic tape storage device; and
rotating the reel driver with a spindle motor, wherein
the reel driver includes spline elements registered circumferentially around a hub of the spindle motor, and
the reel driver is rotated by the spindle motor through a spline joint.

30. The method of claim 29, wherein the reel driver includes a stop element that abuts a planar surface coplanar with a surface of the spindle motor.

31. The method of claim 29, wherein the reel driver includes external spline elements disposed along the axial direction of the reel driver.

32. The method of claim 29, wherein the reel driver includes three or more spline elements.

33. The method of claim 29, wherein the reel driver includes one or more stop elements, wherein the stop elements abut a structure associated with the reel driver assembly after a predetermined axial translation.

34. The method of claim 29, wherein the reel driver includes one or more stop elements disposed circumferentially around a hub of the spindle motor, and the one or more stop elements abut a splined reel plate registered with a planar surface of the spindle motor after a predetermined axial translation.

35. The method of claim 34, wherein the reel plate and stop element are configured to have opposing planar surfaces.

36. The method of claim 29, wherein the spline joint is formed between the reel driver and a reel plate coupled to the spindle motor.

37. The method of claim 29, further including actuating a second motor to translate the reel drive in an axial direction.
